(19) United States
(12) Patent Application Publication
(10) Pub. No.: US 2012/0015280 A1
(43) Pub. Date: Jan. 19, 2012

(54) FLOW FIELD DESIGN FOR HIGH CURRENT FUEL CELL APPLICATIONS

(75) Inventors: Suk-Yal Cha, Fremont, CA (US); Wai-Yin Lau, Fremont, CA (US)

(73) Assignee: Oorja Protonics Inc., Fremont, CA (US)

(21) Appl. No.: 13/182,931

(22) Filed: Jul. 14, 2011

Related U.S. Application Data
(60) Provisional application No. 61/364,691, filed on Jul. 15, 2010.

(51) Int. Cl. H01M 8/10

(52) U.S. Cl. 429/479

(57) ABSTRACT

A fuel cell includes an anode flow field plate having a flow field including a plurality of first lands and a plurality of first channels. Further, the fuel cell includes a cathode flow field plate having a flow field including a plurality of second lands and a plurality of second channels. A membrane electrode assembly is provided between the anode flow field plate and the cathode flow field plate. A width of each of the first channels is greater than a width of each of the second channels.

### CROSS REFERENCE TO RELATED APPLICATION

This application claims priority from U.S. Provisional Application No. 61/364,691 filed on Jul. 15, 2010, the complete disclosure of which is incorporated fully herein by reference.

### TECHNICAL FIELD

The embodiments herein generally relate to fuel cells, and, more particularly, to a fuel cell having flow fields which provide substantially uniform flow distribution, efficient removal of liquids and gases, reduced contact resistance, and robust implementation for production assembly procedures.

### BACKGROUND

A fuel cell provides direct current electricity from two electrochemical reactions. The electrochemical reactions occur at electrodes to which reactants are fed. For example, in a direct methanol fuel cell (DMFC), a negative electrode (i.e., anode) is maintained by supplying a fuel such as methanol, whereas a positive electrode (i.e., cathode) is maintained by supplying oxygen or air. When providing a current, methanol is electrochemically oxidized at an anode electro-catalyst to produce electrons, which travel through an external circuit to a cathode electro-catalyst where the electrons are consumed together with oxygen in a reduction reaction. A circuit is maintained within the DMFC by the conduction of protons in an electrolyte.

A fuel cell stack typically includes a series of fuel cells. Each cell includes a pair of anode and cathode. A voltage across each cell is determined by the type of electrochemical reaction occurring in the cell. For example, for a typical single DMFC, the voltage can vary from 0 V to 0.9 V, depending on a current being generated. The current being generated in the cell depends on the operating condition and design of the cell, such as electro-catalyst composition/distribution and active surface area of a membrane electrode assembly (MEA), characteristics of a gas diffusion layer (GDL), flow field design of anode and cathode bipolar plates, cell temperature, reactant concentration, reactant flow and pressure distribution, reaction by-product removal, and so forth. The reaction area of a cell, number of cells in series, and the type of electrochemical reaction in the fuel cell stack determine a current and hence a power supplied by the fuel cell stack. For example, typical power for a DMFC stack can range from a few watts to several kilowatts.

A fuel cell system typically integrates a fuel cell stack with different subsystems for the management of water, fuel, air, humidification, and thermal condition. These subsystems are sometimes collectively referred to as a balance of the plant (BOP). The interface between the fuel cell stack and the BOP is referred to as a stack manifold. The stack manifold serves as a conduit for bi-directional flow distribution between the BOP and the fuel cell stack. Conduits for bi-directional fluid flows between the stack manifold and individual cells are called headers and are part of anode and cathode plate design.

Further, it is desirable for a volumetric density (e.g., in terms of kilowatts/liter) of a fuel cell stack to be as high as practical, which typically involves a reduction in a stack volume for a particular power delivered by the fuel cell stack. High power (e.g., greater than about 0.5 kilowatts) DMFC stacks typically suffer from mass transport restrictions of anodes and cathodes when operated at higher volumetric densities. In addition, the DMFC stacks can sometimes suffer from irreversible cathode damage arising from gas diffusion layer over-compression and silicon oxide deposition on the gas diffusion layer and the flow field plate of cathode side causing mass transport restriction. The effectiveness of the mass transport is typically affected by the degree of compression of the gas diffusion layers, and other characteristics such as porosity and Teflon content. A certain degree of compression is desirable to reduce Ohmic resistances between the anode flow field plate and the cathode flow field plate, the gas diffusion layers, and the catalyst coated membrane. However, too high a compression can crush fibers forming the gas diffusion layers and close pores through which mass transport occurs which may result in damage of the electrodes.

Therefore, there is a need to develop fuel cells having flow fields which provide substantially uniform flow distribution, efficient removal of liquids and gases, reduced contact resistance, and robust implementation for production assembly procedures

### SUMMARY

In view of the foregoing, an embodiment herein provides a fuel cell having an anode flow field plate having a flow field including a plurality of first lands and a plurality of first channels. Further, the fuel cell includes a cathode flow field plate having a flow field including a plurality of second lands and a plurality of second channels. A membrane electrode assembly is provided between the anode flow field plate and the cathode flow field plate. A width of each of the first channels is greater than a width of each of the second channels.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a DMFC fuel cell stack of an embodiment as disclosed herein;

FIGS. 2a-2e illustrate anode flow field plates according to embodiments as disclosed herein;

FIGS. 3a-3c illustrate a cathode flow field plates according to embodiments as disclosed herein;

FIGS. 4a-4b illustrates membrane electrode assembly (MEA) stacked up with according to an embodiment as disclosed herein; and

FIGS. 5a and 5b illustrate aspects of inlet and outlet ports for flow fields, according to some embodiments of the invention.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

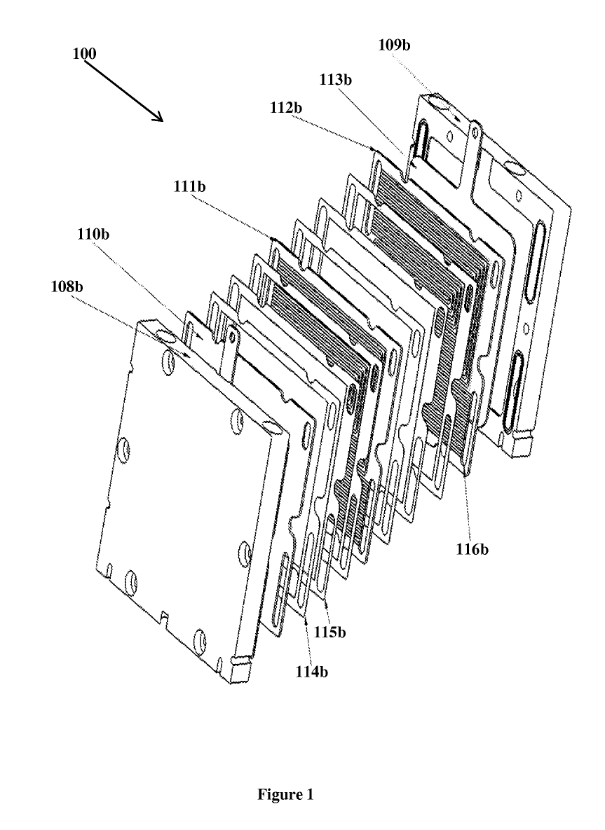

The embodiments herein disclose a composite gasket. Referring now to the drawings, and more particularly to FIGS. 1-5b, where similar reference characters denote corresponding features consistently throughout the figures, there are shown embodiments.

FIG. 1 illustrates a fuel cell stack 100 according to an embodiment. The fuel cell stack 100 includes two end plates 108b and 109b having respective manifolds, a plurality of monopolar plates 110b and 112b, a variable number of bipolar plates 111b. The fuel cell stack 100 further includes a variable number of membrane electrode assemblies (MEAs) 115b. The membrane electrode assembly 115b is sandwiched between the bipolar plate 111b and the monopolar plate 110b. Further, the fuel cell stack 100 is provided with two current collector plates 113b, and four tie rods (not shown) that hold the stack together and are attached through tie rod holes (not shown). Each of the end plates 108b and 109b are made of fiber-reinforced plastic (e.g., NEMA G-10). It is also within the scope of the invention that the end plates 108b and 109b be made of materials which have properties of mechanical strength and corrosion tolerance.

The bipolar plates 111b are made of graphite. It is to be noted that the bipolar plate 111b can also be made of a metal or an alloy. The bipolar plate 111b has two planar surfaces each of which define flow fields. A flow field on one planar surface facilitates a flow of anode reactants and by-products, and a flow field on the other planar surface facilitates cathode reactants and by-products.

Further, the monopolar plates 110b and 112b are made of graphite. It is to be noted that the monopolar plates 110b and 112b can be made of a metal or an alloy. Each of the monopolar plates 110b and 112b has a planar surface which defines a flow field therein. Each of the monopolar plates 110b and 112b defining flow field is configured to facilitate flow of reactants and by-products at either anode or cathode. The flow of reactants to the flow fields from the end plates 108b and 109b and the flow of unused reactants and by-products from the flow fields to the end plates 108b and 109b occur through headers 116b defined in the monopolar plates 110b and 112b and the bipolar plates 111b. A pair of anode and cathode flow fields with a MEA sandwiched there between is called a cell. In the illustrated embodiment, the manifolds of the end plates 108b and 109b act as distribution conduits for fluids between the cells in the fuel cell stack 100 and a balance of plant (BOP).

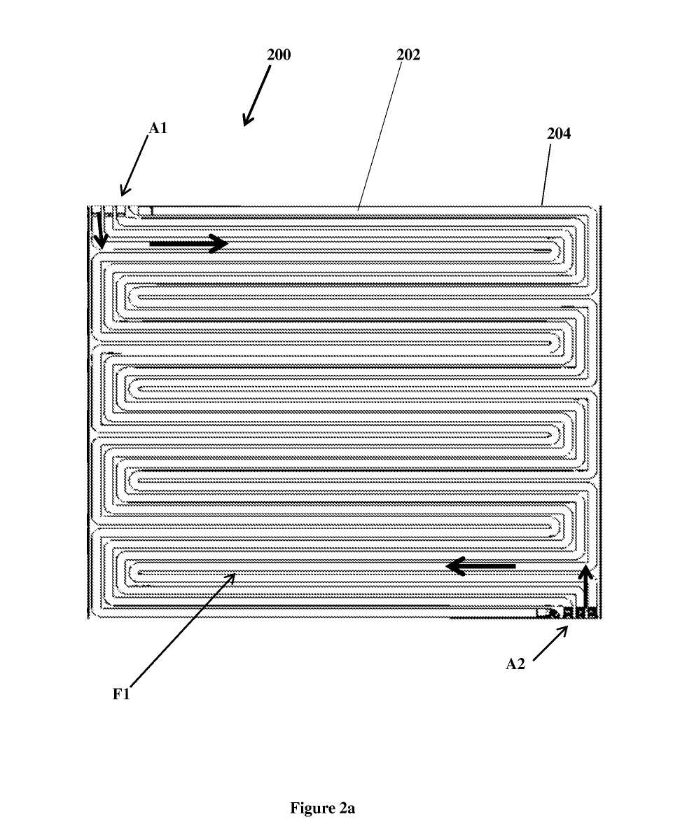

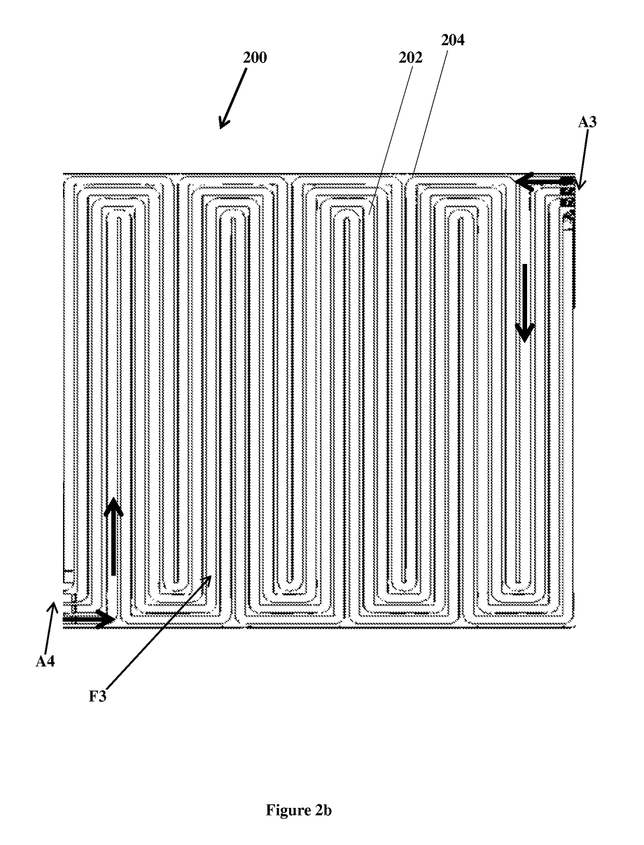

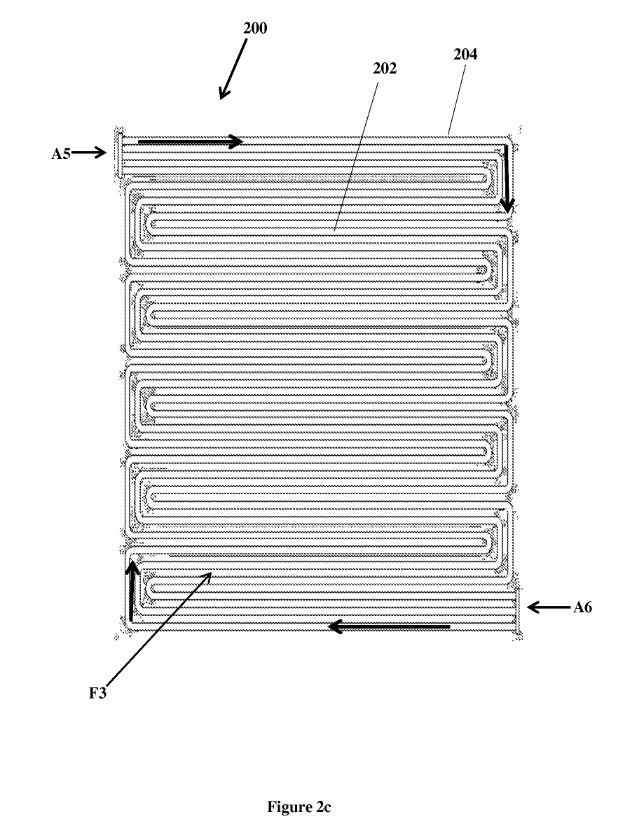

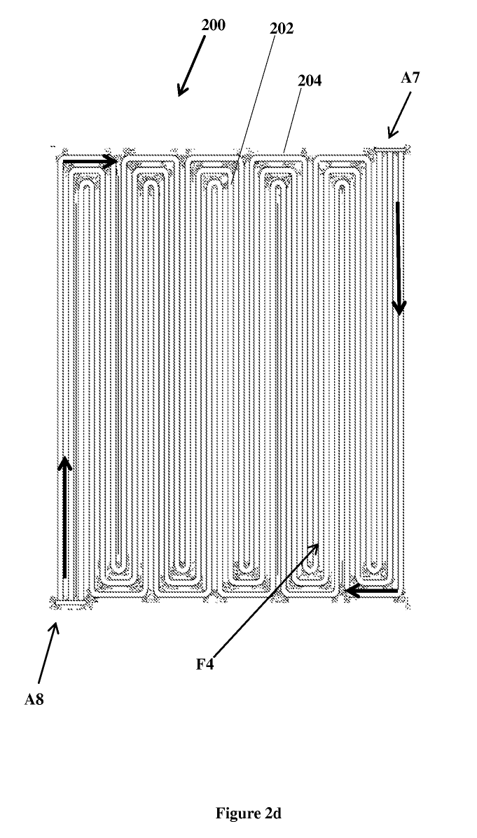

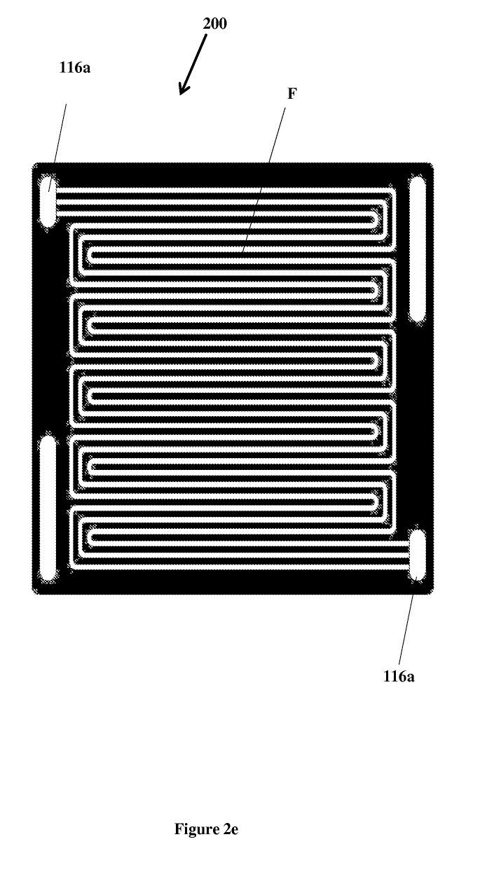

FIG. 2a shows an anode flow field plate 200 having a flow field F1 according to an embodiment. The flow field F1 has a plurality of lands 204 and a plurality of channels 202. Each of the channels 202 is defined between two adjacent lands 204. Each of the channels 202 is configured to be in fluid communication with a first port A1 and a second port A2. Each of the first and second ports A1 and A2 allows a passage of the fuel to or from the channels 202. In one embodiment, the fuel enters from the second port A2 and an initial flow of the fuel is vertically upwards and subsequently side wards relative to the flow field F1 and the anode flow field plate 200 as shown by the arrows. In another embodiment, the fuel enters from the first port A1 and an initial flow of the fuel is vertically down wards and subsequently side wards relative to the flow field F1 and the anode flow field plate 200 as shown by the arrows. Further, it has to be noted that with respect to the flow field F1, a length of a portion of a channel 202 configured to provide a horizontal flow (or sideward flow) is greater than a length of the portion of the channel 202 configured to provide a vertical flow (upward or downward flow).

F1G. 2b shows an anode flow field plate 200 having a flow field F2 according to another embodiment. The flow field F2 has a plurality of lands 204 and a plurality of channels 202. Each of the channels 202 is defined between two adjacent lands 204. Each of the channels 202 is configured to be in fluid communication with a first port A3 and a second port A4. Each of the first and second ports A3 and A4 allows a passage of the fuel to or from the channels 202. In one embodiment, the fuel enters from the first port A3 and an initial flow of the fuel is side wards and subsequently upwards relative to the flow field F2 and the anode flow field plate 200 as shown by the arrows. In another embodiment, the fuel enters from the second port A4 and an initial flow of the fuel is side wards and vertically down wards, subsequent to side ward flow, relative to the flow field F2 and the anode flow field plate 200 as shown by the arrows. Further, it has to be noted that with respect to the flow field F2, a length of a portion of a channel 202 configured to provide a vertical flow (upward or downward flow) is greater than a length of the portion of the channel 202 configured to provide a horizontal flow (sideward flow).

FIG. 2c shows an anode flow field plate 200 having a flow field F3 according to another embodiment. The flow field F3 has a plurality of lands 204 and a plurality of channels 202. Each of the channels 202 is defined between two adjacent lands 204. Each of the channels 202 is configured to be in fluid communication with a first port A5 and a second port A6. Each of the first and second ports A5 and A6 allows a passage of the fuel to or from the channels 202. In one embodiment, the fuel enters from the second port A6 and an initial flow of the fuel is side wards and subsequently upwards relative to the flow field F3 and the anode flow field plate 200 as shown by the arrows. In another embodiment, the fuel enters from the first port A5 and an initial flow of the fuel is side wards and vertically down wards, subsequent to side ward flow, relative to the flow field F3 and the anode flow field plate 200 as shown by the arrows. Further, it has to be noted that with respect to the flow field F3, a length of a portion of a channel 202 configured to provide a horizontal flow (sideward flow) is greater than a length of the portion of the channel 202 configured to provide a vertical flow (upward flow).

FIG. 2d shows an anode flow field plate 200 having a flow field F4 according to another embodiment. The flow field F4 has a plurality of lands 204 and a plurality of channels 202. Each of the channels 202 is defined between two adjacent lands 204. Each of the channels 202 is configured to be in fluid communication with a first port A7 and a second port A8. Each of the first and second ports A7 and A8 allows a passage of the fuel to or from the channels 202. In one embodiment, the fuel enters from the second port A8 and an initial flow of the fuel is vertically upward and subsequently sideward relative to the flow field F4 and the anode flow field plate 200 as shown by the arrows. In another embodiment, the fuel enters from the first port A7 and an initial flow of the fuel is vertically downwards and subsequently sideward relative to the flow field F4 and the anode flow field plate 200 as shown by the arrows. Further, it has to be noted that with respect to the flow field F4, a length of a portion of a channel 202 configured to provide a vertical flow (upward or downward flow) is greater than a length of the portion of the channel 202 configured to provide a horizontal flow (sideward flow).

FIG. 2e shows an anode flow field plate 200 having a flow field F with header ports 116a. The embodiment of FIG. 2e is similar to the embodiment as provided in FIG. 2c and the corresponding description.

Now with respect to FIGS. 2a, 2b, 2c, 2d and 2e, a methanol solution or other fuel enters the flow field (F1, F2, F3, F4) through a port (A1, A2, A3, A4, A5, A6, A7, A8). The flow into the flow field (F1, F2, F3, F4) is supplied directly through a header port 116a by a stiff bridge created from graphite, stainless steel of type 316, or any other suitable stiff and chemically inert material. A cross-sectional area of the entry port or an area under the bridge is about 3 percent to about 5 percent that of headers 116a to create a back pressure for the flow into cells. In the illustrated embodiments, there are between 3 and 6 channels 202 available for liquid flow. The number of channels 202 can be kept minimal to ensure adequate flow in each channel, thereby reducing or minimizing fuel flow starvation issues. A width of lands 204 and channels 202 can be about the same at about 1 to about 2 mm. A length of straight sections of the lands 204 and channels 202 can be varied to optimize the flow field based on a concentration of the methanol solution used. In an embodiment the length is about 1,000 mm to about 2,000 mm, such as from about 1,500 mm to about 1,600 mm. A depth of the channels 202 is from about 0.7 mm to about 1 mm. A volume of the channels 202 can thus be made sufficiently high to accommodate a high volume of carbon dioxide gas produced at high current densities. In some of the illustrated embodiments, the channels 202 have multiple bends of about 90 degrees, which aid in creating a high pressure drop for the fuel flow. The associated volume, along with the resulting higher pressure drop in the channels 202, ensures efficient carbon dioxide removal. The fuel flow can be generally from the ports A2, A4, A6 and A8 located at a bottom portion of the anode flow field plate 200 thereby enhancing carbon dioxide removal. The flow orientations as depicted in the embodiments of FIGS. 2a-2e can have respective benefits for different operating conditions at high currents.

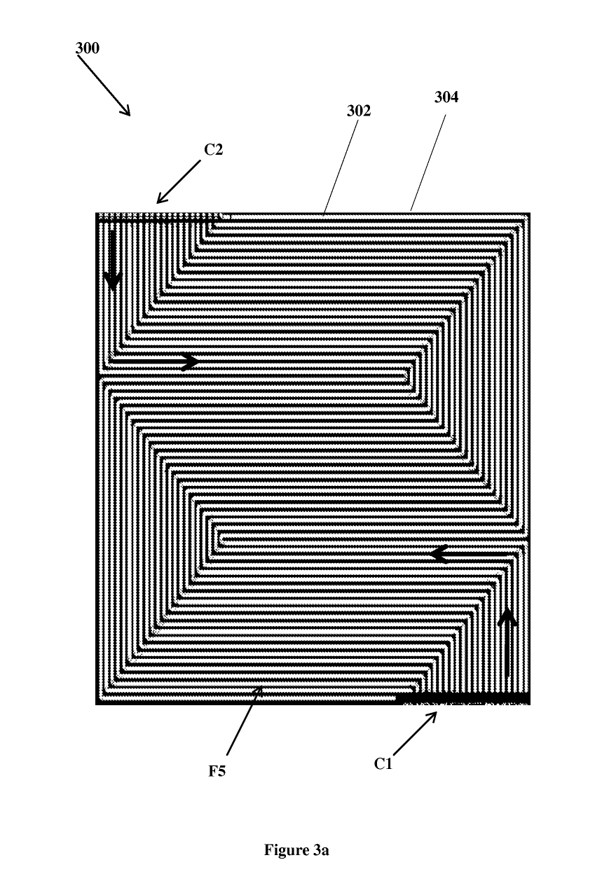

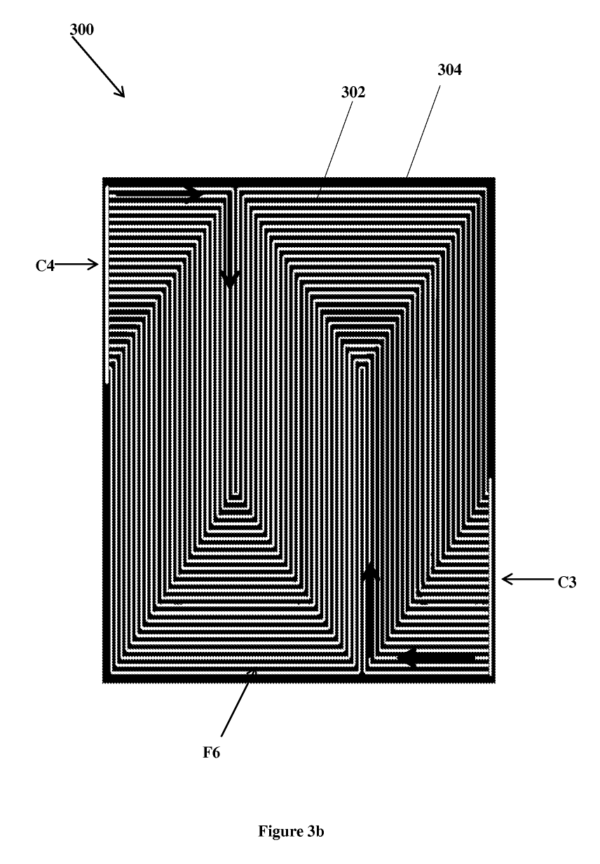

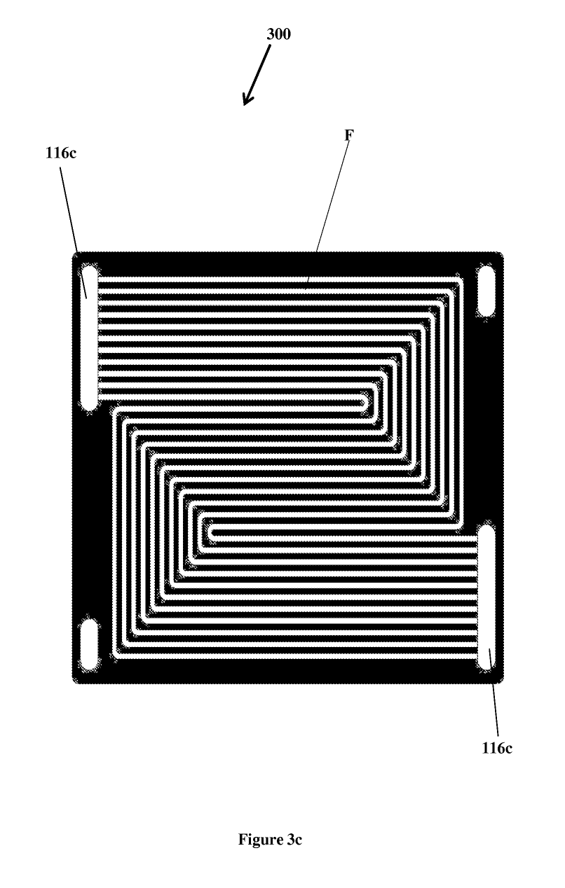

FIG. 3a shows a cathode flow field plate 300 having a flow field F5 according to an embodiment. The flow field F5 has a plurality of lands 304 and a plurality of channels 302. Each of the channels 302 is defined between two adjacent lands 304. Each of the channels 302 is configured to be in fluid communication with a first port C1 and a second port C2. Each of the first and second ports C1 and C2 allows a passage of air to or from the channels 302. In one embodiment, the air enters from the first port C1 and an initial flow of the fuel is vertically upwards and subsequently sidewards relative to the flow field F5 and the cathode flow field plate 300 as shown by the arrows. In another embodiment, the air enters from the second port C2 and an initial flow of the fuel is vertically downwards and subsequently side wards, relative to the flow field F5 and the anode flow field plate 300 as shown by the arrows.

FIG. 3b shows a cathode flow field plate 300 having a flow field F6 according to another embodiment. The flow field F5 has a plurality of lands 304 and a plurality of channels 302. Each of the channels 302 is defined between two adjacent lands 304. Each of the channels 302 is configured to be in fluid communication with a first port C3 and a second port C4. Each of the first and second ports C1 and C2 allows a passage of air to or from the channels 302. In one embodiment, the air enters from the first port C3 and an initial flow of the fuel is side wards upwards and subsequently upwards relative to the flow field F6 and the cathode flow field plate 300 as shown by the arrows. In another embodiment, the air enters from the second port C4 and an initial flow of the fuel is side wards and subsequently down wards, relative to the flow field F6 and the anode flow field plate 300 as shown by the arrows.

FIG. 3c shows a cathode flow field plate 300 having a flow field F with header port 116b.

Now with respect to FIGS. 3a, 3b, and 3c air enters a flow field (F5, F6) through a port (C1, C2, C3, C4). The flow into the flow field (F5, F6) is supplied directly through a header 116c or by a stiff bridge created from graphite, stainless steel of type 316, or any other suitable stiff and chemically inert material. A cross-sectional area of the entry port or an area under the bridge is about 20 percent to about 30 percent that of manifold headers to create a back pressure for the flow into cells. In the illustrated embodiments, there are between 3 and 30 channels available for gas flow. A width of lands 304 and channels 302 can be about the same at about 0.8 mm to about 1.5 mm. A length of straight sections of the lands 304 and channels 302 can be varied to optimize the flow field based on a concentration of a methanol solution used. A desired length can be about 200 mm to about 1,000 mm, such as from about 300 mm to about 500 mm. A depth of the channels 302 can be from about 0.5 mm to about 1 mm. The number of channels 302, along with a volume of the channels 302, establishes a desired pressure drop in the channels 302. These features can be optimized based on an air-delivery system that is used. A cathode stream pressure drop is about 1 psig to about 2 psig under high current operations. The various dimensions noted above allow a fuel cell stack to operate efficiently at the aforementioned pressure drop. The air flow can be generally from the ports C1 and C3. The flow orientations as depicted in FIGS. 3a-3c can have respective benefits for different operating conditions at high currents.

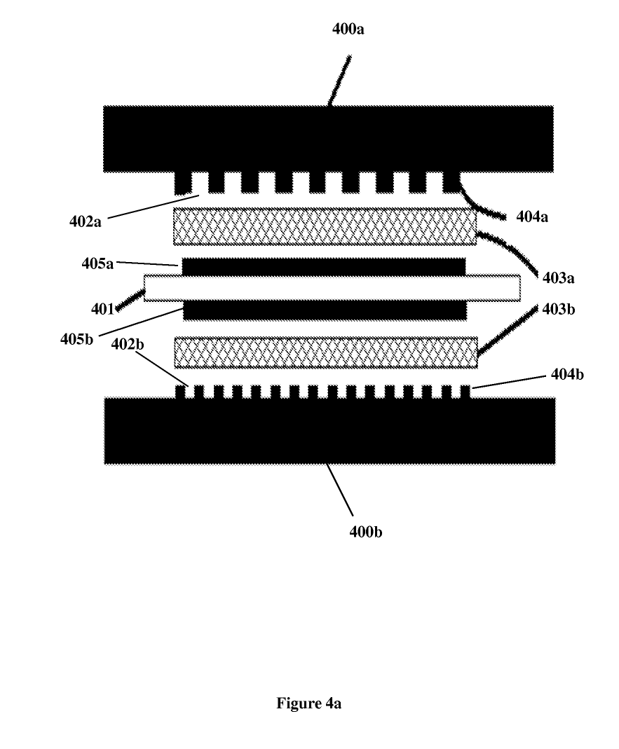

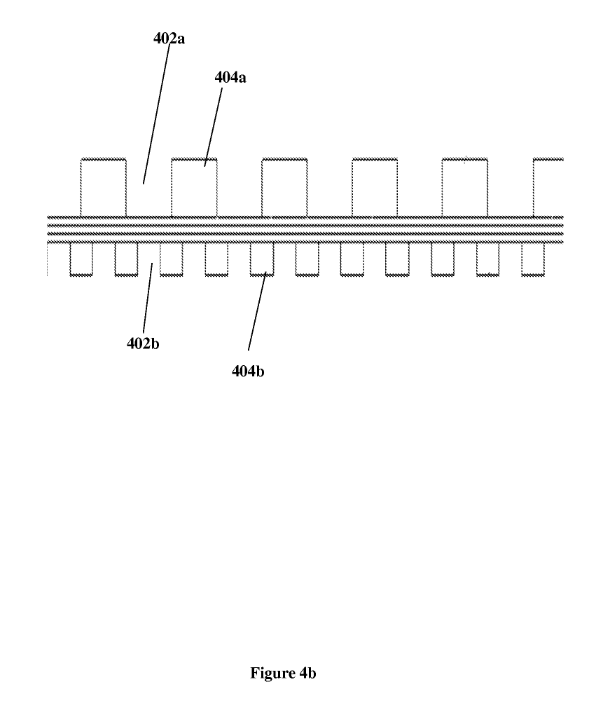

FIG. 4a illustrates membrane electrode assembly MEA stack up according to an embodiment of the invention. An anode flow field plate 400a includes a plurality of lands 404a defining a plurality of channels 402a. The anode flow field plate 400a is configured to be in contact with a first gas diffusion layer (GDL) 405a provided near the anode. The first gas diffusion layer 403a is in contact with a first catalyst layer 405a. The first catalyst layer 405a for the anode is interfaced with the proton conductive polymer membrane 401. The proton conductive polymer membrane 401 is a Perfluro sulfonic acid (PFSA) membrane. Similarly, a cathode flow filed plate 400b, includes a plurality of lands 404b defining a plurality of channels 402b. The cathode flow field plate 400b is configured to be in contact with a second gas diffusion layer 403b provided near the cathode. The gas diffusion layer 403b is in contact with a second catalyst layer 405b. The second catalyst layer 405b is interfaced with the proton conductive polymer membrane 401.

In general, the assembly of gas diffusion layers (GDLs) 403a and 403b, the catalyst layers 405a and 405b, and the membrane 401 is referred to as membrane electrode assembly (MEA). The assembly of catalyst layers 405a and 405b and the membrane 401 is referred to as catalyst coated membrane (CCM).

It may be noted from the embodiment of FIG. 4, that the number of channels 402a provided in the anode flow field plate 400a is lesser than the number of channels 402b provided in the cathode flow field plate 400b thereby ensuring that there is a comparable flow of fuel into each of the channels 402a. Further, a width of each of the channels 402a and the lands 404a is greater than a respective width of each of the channels 402b and the lands 404b. Further, a depth of each of the channels 402b is lesser than a depth of each of the channel 402a. Carbon dioxide production can create a larger pressure drop in the anode channels 402a, and, thus, the anode channels 402a can be designed with a larger channel volume.

In a fuel cell stack, the entire setup is compressed to a set a compressed height for gas diffusion layers 403a and 403b (GDL). Under compression, each of the gas diffusion layers (GDLs) 403a and 403b are forced towards the CCM and the flow fields plates 400a and 400b. Enhancing the anode-to-cathode land contact ensures lower contact resistance. However, increasing the contact beyond a certain optimum level can sometimes result in higher mass transport losses and higher pressure drops in the channels 402a and 402b.

FIG. 4b illustrates lands 404a and 404b and channels 402a and 402b of the flow field plates 400a and 400b with respect to each other when arranged in a fuel cell stack. When viewed in conjunction with the flow patterns in FIGS. 2a, 2b, 2c, and 2d and FIGS. 3a and 3b, it can be observed that there is a substantially parallel orientation (co-flow or counter-flow) of anode and cathode flows in about 40 percent of a total flow field area. Further, FIG. 4b illustrates land-on-land contact across the MEA 401 and the GDLs 403a and 403b of FIG. 4a. Since a pitch of the anode flow field (i.e., a width of land plus a width of channel plus a width of land) is larger than that of the cathode flow field, there is little or no occurrence when most, or all, of the lands 404a and 404b will be interfacing with most, or all, of the channels 402a and 402b. It is desirable to reduce the occurrence of land-on-channel alignment to prevent gas diffusion layers 403a and 403b from bending and eventual crushing which causes severe mass transport losses, leading to loss of performance and durability. In the remaining about 60 percent of the flow field area, there is cross-flow where the anode and cathode flows are substantially perpendicular to each other. Under such circumstances, the level of land-on-land contact is high, thereby achieving the desired result of low contact resistance.

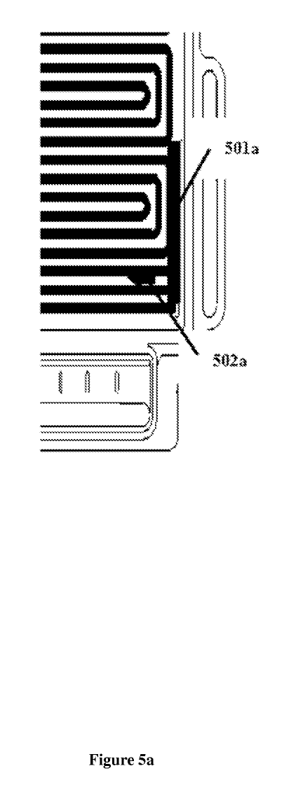

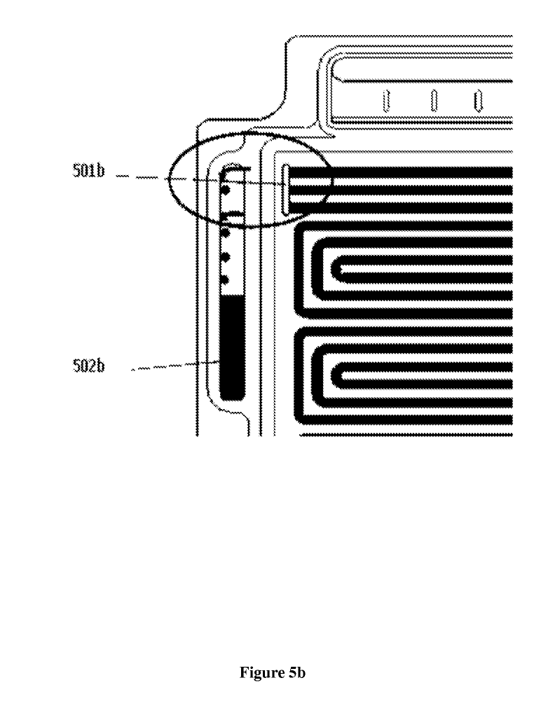

FIGS. 5a and 5b illustrate aspects of inlet and outlet ports for anode flow fields, according to some embodiments of the invention. FIG. 5a illustrates an arrangement 502a of an inlet of an anode flow field, such as illustrated in FIGS. 2a, 2b, 2c, and 2d. Since the anode fuel inlet is positioned at, or near, the bottom of the flow field, proper positioning of anode fuel inlet “slits” can facilitate uniform distribution of fuel flow into anode channels. A fuel level 501a in an anode header port creates a pressure head that further facilitates driving the fuel flow into the anode channels.

Further, FIG. 5b illustrates an arrangement of an outlet of an anode flow field, such as illustrated in FIGS. 2a, 2b, 2c, and 2d. Anode exit “slits” 501b are positioned at, or near, the top of a manifold header 502b. Due to a high volume of carbon dioxide in the outlet of the anode flow field, it can be desirable to establish gas separation in the exit manifold. Proper positioning of the anode exit “slits” 501b at, or near, the top of the manifold header 502b facilitates the separation of a liquid by the loss of momentum that arises from the liquid striking a wall opposite the exit port. Thus, the liquid separates out at, or near, the bottom of the manifold header 502b.

In some embodiments, an anode flow field for high current DMFC operations can include one or more of the following features:

(1) Channel numbers ranging from 3 to 8, depending on current density, active area, and operating methanol concentration, wherein channels are substantially continuous with little or no splitting, branching or joining.

(2) Channel length ranging from about 1,000 mm to about 2,000 mm, depending on active area and operating methanol concentration.

(3) Channel depth and width are in the range of about 0.7 mm to about 1 mm and about 1 mm to about 2 mm, respectively.

(4) Channel geometry is varied based on operating current density.

(5) Channel-to-land width ratio varies from about 0.5 to about 3.

(6) Channels for one embodiment have reactants flowing in a generally horizontal direction and a generally upward direction.

(7) Channels for another embodiment have reactants flowing in alternating upward and downward directions.

(8) Plates are designed for current density operations from about 150 mA/cm² to about 500 mA/cm².

(9) Locations of a header port and slits at an inlet facilitate entry of anode fuel into channels.

(10) Anode entry slit area of about 0.1 cm² to about 1 cm² facilitates substantially uniform flow distribution.

(11) Area of slits or area under bridges is about 3 percent to about 8 percent of area of a header in a plate.

(12) Area of exit slits or area under bridges is oversized up to about 2 times relative to an entry slit to facilitate carbon dioxide removal.

(13) Exit header is oversized up to about 2 times to facilitate carbon dioxide removal.

(14) Exit header is positioned such that it acts as a primary carbon dioxide-liquid separation chamber.

In some embodiments, a cathode flow field for high current DMFC operations can include one or more of the following features:

(1) Plates are designed for current density operations from about 150 mA/cm² to about 500 mA/cm².

(2) Channel numbers ranging from 20 to 35, wherein channels are substantially continuous with little or no splitting, branching or joining.

(3) Channel length ranging from about 200 mm to about 1,000 mm, depending on active area, wherein channels are substantially continuous with little or no splitting, branching or joining.

(4) Channel width varies from about 0.8 mm to about 1.5 mm.

(5) Channel-to-land width ratio varies from about 0.5 to about 3.

(6) Channels for one embodiment have reactants flowing in a generally horizontal direction and a generally upward direction.

(7) Channels for another embodiment have reactants flowing in alternating upward and downward directions.

(8) High pressure drop from a header feeding channels facilitates substantially uniform reactant distribution between channels.

(9) Area of slits or area under bridges is about 20 percent to about 30 percent of area of a header in a plate.

(10) Exit header is positioned such that it acts as a primary water-vapor phase separation chamber.

In some embodiments, a DMFC stack can include one or more of the following features:

(1) A DMFC stack operating at low pressure drops of about 0.5 psi to about 2 psi on the cathode side for high current density operation.

(2) A width of graphite ribs bordering gaskets is sized appropriately to reduce or minimize breakage from gasket creep or swell due to contact with a methanol solution.

(3) Optimization of anode and cathode parallel overlap in the range of about 30 percent to about 40 percent of a total flow field area.

(4) An anode pitch in the range of about 0.4 cm to about 0.6 cm, and a cathode pitch in the range of about 0.2 cm to about 0.4 cm.

(5) Ramps at entries of flow fields to reduce turbulence in flows.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A fuel cell comprising:
an anode flow field plate having a flow field including a plurality of first lands and a plurality of first channels;
a cathode flow field plate having a flow field including a plurality of second lands and a plurality of second channels; and
a membrane electrode assembly, wherein,
a width of each of said first channels is greater than a width of each of said second channels.

2. The fuel cell as claimed in claim 1, wherein a number of first channels is more than a number of second channel.

3. The fuel cell as claimed in claim 2, wherein a pitch of the anode flow field plate is greater than a pitch of the cathode flow field plate.

4. The fuel cell as claimed in claim 3, wherein the pitch of the anode flow field plate is 2 to 3 times greater than the pitch of the of cathode flow field plate.

5. The fuel cell as claimed in claim 3, wherein a depth of each of the first channels is greater than a depth of each of the second channels.

6. The fuel cell as claimed in claim 2, wherein a length of a portion of each of first channel configured to provide a horizontal flow of fuel is greater than a length of a portion of each of the first channel configured to provide a vertical flow.

7. The fuel cell as claimed in claim 2, wherein a length of a portion of each of first channel configured to provide a vertical flow of fuel is greater than a length of a portion of each of the first channel configured to provide a horizontal flow.

8. The fuel cell as claimed in claim 6, wherein the fuel is allowed to pass through a port provided at a bottom of the flow field of the anode flow field plate.

9. The fuel cell as claimed in claim 7, wherein the fuel is allowed to pass through a port provided at a bottom of the flow field of the anode flow field plate.

10. The fuel cell as claimed in claim 6, wherein the length of the portion of each of first channel configured to provide a horizontal flow of fuel is in the range of 1000 mm to 2000 mm.

11. The fuel cell as claimed in claim 6, wherein the length of the portion of each of first channel configured to provide a horizontal flow of fuel is in the range of 1500 mm to 1600 mm.

12. The fuel cell as claimed in claim 1, wherein a length a straight portion of each of the second channels is in the range of 200 mm to 1000 mm.

13. The fuel cell as claimed in claim 1, wherein a length a straight portion of each of the second channels is in the range of 300 mm to 500 mm.

14. The fuel cell as claimed in claim 5, wherein the depth of the second channel is in the range of 0.5 mm to 1 mm.

15. The fuel cell as claimed in claim 3, wherein the pitch of the anode flow field plate is in the range of about 0.4 cm to about 0.6 cm and the pitch of the cathode flow field plate is in the range of about 0.2 cm to about 0.4 cm.
